(19) United States
(12) Patent Application Publication
(10) Pub. No.: US 2010/0276396 A1
(43) Pub. Date: Nov. 4, 2010

(54) APPARATUS AND METHOD FOR WELDING

(76) Inventors: Paul Cooper, New South Wales (AU); Ajit Godbolb, New South Wales (AT); John Norrish, New South Wales (AT)

Correspondence Address: The BOC Group, Inc., 575 MOUNTAIN AVENUE, MURRAY HILL, NJ, 07974-2082, US

(21) Appl. No.: 12/293,734

(22) PCT Filed: Mar. 21, 2007
(86) PCT No.: PCT/AU2007/000258

§ 371 Date: Sep. 19, 2008

(30) Foreign Application Priority Data
Mar. 21, 2006 (AU) 2006901445
Jun. 22, 2006 (AU) 2006903373
Dec. 15, 2006 (AU) 2006907023

(51) Int. Cl. B23K 9/16

(52) U.S. Cl. 219/74

(57) ABSTRACT

The present invention relates to arc welding torch and a method of extracting fume gas from a welding site. The torch comprises a metal electrode and at least one shield gas port adapted to direct a shield gas curtain around the metal electrode and a welding site. At least one shroud gas port is spaced radially outward from the shield gas port and adapted to impart to an exiting shroud gas a radially outward component of velocity. Fume gas is preferably extracted from a position radially intermediate the shield gas curtain and the shroud gas curtain.

### FIELD OF THE INVENTION

The present invention relates to welding, and in particular to a welding method and apparatus providing improved fume gas extraction efficiency.

### BACKGROUND OF THE INVENTION

Any discussion of the prior art throughout the specification should in no way be considered as an admission that such prior art is widely known or forms part of the common general knowledge in the field.

Welding is key enabling technology in many sectors of industry. For example, Gas Metal Arc Welding (GMAW), sometimes referred to as Metal Inert Gas (MIG) or Metal Active Gas (MAG) welding accounts for some 45% of all weld metal deposited in Australia (Kuebler. R., Selection of Welding Consumables and Processes to Optimise Weld Quality and Productivity, Proceedings of the 53rd WTIA Annual Conference, Darwin, 11-13 October 2005).

In GMAW, the intense heat needed to melt the metal is provided by an electric arc struck between a consumable electrode and the workpiece. The welding ‘gun’ guides the electrode, conducts the electric current and directs a protective shielding gas to the weld. The intense heat generated by the GMAW arc melts the electrode tip, and the molten metal is transferred to the workpiece. Some of the molten metal may evaporate, and the vapour may undergo oxidation forming a fume plume containing a mixture of vapour, metal oxides, gases and other more complex compounds. Recent international activity has highlighted some potential risks of exposure to this welding fume (McMillan, G., International Activity in Health and Safety in Welding—International Institute of Welding, International Conference on Health and Safety in Welding and Allied Processes, Copenhagen, 9-11 May 2005) and it is generally acknowledged that breathing zone exposure should be minimised.

Analysis of GMAW-induced flow fields indicates that their structure results from a complex interplay involving:
high temperature, high speed plasma jet flow in the arc column;
molten metal transfer, vaporisation and recondensation;
hazardous gas/fume formation in the immediate vicinity of the arc;
the fluid dynamics of shielding gas flow driven by forced convection; and
natural (buoyancy-driven) convection processes due to the hot gases.

It has been recognised that one of the best ways to minimize fume exposure for the welding operator is to extract the fume close to its source (Wright, et al, Proc. Int. Conf. on Exploiting Welding in Prod Tech., The Welding Institute, The Institution of Production Engineers, London, 22-24 April (1975)). This typically means incorporating an extraction device on the welding torch itself. For example, see U.S. Pat. No. 2,768,278 in which an annular exhaust hood is disposed directly on a welding torch. However, this device is difficult to use because the size of the hood restricts the welding operator's line of sight to the welding site. See also U.S. Pat. No. 5,079,404 in which a positionable goose-neck extraction port is provided on the handle of the welding torch. This device is also relatively difficult to use because the welding operator must constantly re-position the port above the arc to efficiently capture the fume as the torch is moved over the workpiece.

However, the most common forms of extraction devices are those described in, for example U.S. Pat. No. 3,798,409, U.S. Pat. No. 4,016,398 and WO 91/07249, in which an external concentric sleeve is provided on the welding torch to extract the welding fume. These devices have been found to be inadequate because in order to remove any fume, excessive suction is required. Strong suction tends to draw away the essential shielding gas envelope from around the weld, thus adversely affecting weld quality, entraining air and potentially increasing fume generation. Furthermore, the location of the extraction port is such that ambient air may be extracted in preference to the fume. The fundamental reason for the inadequacy of an external fume extraction sleeve surrounding the shield gas envelope is that a flow field which is created by virtue of the positioning of the work normal to the axis of the welding torch causes the formation of a radially outward gas flow along the surface of the work (referred to herein by the term ‘wall jet’) and this wall jet is not significantly affected by the external suction. Even with this very strong suction it has been found that the flow in the wall jet remains directed radially outward. This flow carries the bulk of the fume with it, with the result that the breathing zone of the operator is still likely to contain unacceptably high concentrations of the fume.

A more recent variation is disclosed in U.S. Pat. No. 6,380,515 in which a fume extraction port surrounds the welding electrode and a concentric inert gas supply port surrounds the extraction port. Whilst this configuration assists in confining the bulk of the fume to a region close to the arc, and therefore makes the task of extracting fume relatively easy compared to prior art devices, the configuration also dilutes the inert gas concentration to unacceptably low levels with ambient air in the vicinity of the arc and weld pool. This is irrespective of the relative flow rate of shielding gas and rate of fume extraction.

Other devices intended for fume extraction are designed for large-scale fume exhaustion, where the point of extraction is a long distance away from the source of the contaminant. For example see U.S. Pat. No. 4,043,257 in which an exhaustion duct for a place of work is provided having a circumferential radially projecting aperture surrounding its entrance for producing a radially outward flow of air. However, a scaled-down version of this device adapted to a GMAW torch would be incapable of providing fume extraction and simultaneous adequate shielding of the arc and weld pool from atmospheric contamination. Also, such an aperture would severely restrict the welding operator's line of sight to the welding site.

The welding electrode used in GMAW is a continuous wire, typically of high purity. The wire may be copper plated as a means of assisting in smooth feeding, electrical conductivity, and protecting the electrode surface from rust. Self Shielded Flux Cored Arc Welding (SSFCAW) is similar to GMAW as far as operation and equipment are concerned. However, the major difference between these welding processes relates to the electrodes. As the name suggests, SSFCAW utilises an electrode consisting of a tube containing a flux core, the electrode being in the form of a continuous wire. The flux core generates in the arc the necessary shielding without the need for an external shielding gas. Self shielded flux-cored wires ensure good welding manoeuvrability regardless of unfavourable welding positions, such as vertical and overhead positions. Such electrodes are sometime also known as “self-shielding” flux cored electrodes or “in-air” welding electrodes.

In addition to the self-shielding, self-shielded flux cored electrodes are also typically designed to produce a slag covering for further protection of the weld metal as it cools. The slag is then manually removed by a chipping hammer or similar process. The main advantage of the self-shielding method is that its operation is somewhat simplified because of the absence of external shielding equipment.

In addition to gaining its shielding ability from gas forming ingredients in the core, self-shielded electrodes typically also contain a high level of deoxidizing and denitrifying alloys in the core. The composition of the flux core can be varied to provide electrodes for specific applications, and typical flux ingredients include the following:
Deoxidizers such as aluminium, magnesium, titanium, zirconium, lithium and calcium.
Slag formers such as oxides of calcium, potassium, silicon or sodium are added to protect the molten weld pool from the atmosphere.
Arc stabilizers such as elemental potassium and sodium help produce a smooth arc and reduce spatter.
Alloying elements such as molybdenum, chromium, carbon, manganese, nickel, and vanadium, are used to increase strength, ductility, hardness and toughness.
Gasifiers such as fluorspar and limestone are usually used to form a shielding gas.

A typical consumable self-shielding electrode is disclosed in U.S. Pat. No. 3,805,016 in which carbonates are included in the flux. The carbonates are thermally decomposed during the welding process into oxide and CO₂ gas; the CO₂ gas serving as the arc protecting atmosphere. Similar electrodes are disclosed in U.S. Pat. No. 3,539,765.

Another typical electrode is disclosed in U.S. Pat. No. 4,833,296, in which metallic aluminium is incorporated into the flux and which is used to develop the self-shielding feature by providing a scavenger for nitrogen and oxygen in the arc and weld pool. Similar electrodes are disclosed in U.S. Pat. No. 5,365,036, U.S. Pat. No. 4,072,845 and U.S. Pat. No. 4,804,818.

Further electrodes are disclosed in GB 1,123,926, in which the electrodes contain one or more fluorides or chlorides of alkali metals, alkaline earth metals, magnesium or aluminium or one or more mixed fluorides or chlorides. These electrodes are highly deoxidised which suggest that the electrodes are intended for use without an externally supplied shielding gas. Similar electrodes are disclosed in U.S. Pat. No. 3,566,073.

Whatever the type of self-shielding welding electrode a welding fume is generated in use which, notwithstanding the presence of a conventional fume extraction system, may pollute the atmosphere around the welder. In all cases it is expected that self-shielded FCAW will generate increased fume compared to GMAW processes.

Gas-tungsten arc welding (GTAW) (sometimes referred to as Tungsten-Inert Gas (TIG) welding) and Plasma Arc Welding (PAW) are welding processes that melt and join metals by heating them with an arc established between a nonconsumable tungsten electrode and the metals. In GTAW, the torch holding the tungsten electrode is water cooled to prevent overheating and is connected to one terminal of the power source, with the workpiece being connected to the other terminal. The torch is also connected to a source of shielding gas which is directed by a nozzle on the torch toward the weld pool to protect it from the air.

PAW is similar to GTAW but in addition to the shielding gas, the torch includes an additional gas nozzle forming an orifice through which an additional shaping gaseous flow (sometimes called “orifice gas flow”) is directed. This shaping gas passes through the same orifice in the nozzle as the plasma and acts to constrict the plasma arc due to the converging action of the nozzle. Whereas the tungsten electrode protrudes from the shielding gas nozzle in GTAW, it is recessed and spaced inwardly of the orifice in the gas nozzle in PAW.

It is an object of the present invention to overcome or ameliorate at least one of the disadvantages of the abovementioned prior art, or to provide a useful alternative.

### DISCLOSURE OF THE INVENTION

According to a first aspect the present invention provides an arc welding torch having a welding electrode and at least one shield gas port adapted to direct a shield gas curtain around said welding electrode and a welding site, and at least one shroud gas port spaced radially outward from the shield gas port and adapted to impart to an exiting shroud gas a radially outward component of velocity.

According to a second aspect of the present invention there is provided an arc-welding torch for use in a self-shielded arc welding process having a self-shielding welding electrode adapted to generate in use an arc-protecting gas curtain around the arc and the weld, and at least one shroud gas port spaced radially outward from said welding electrode and adapted to impart to an exiting shroud gas a radially outward component of velocity.

The Applicants have discovered that the torch according to the present invention provides surprisingly improved fume extraction to the welding site. For GMAW applications, the welding electrode is a metal electrode preferably in the form of a consumable welding electrode. For GTAW and PAW applications the welding electrode is a metal electrode in the form of a (non-consumable) tungsten electrode. However, for SSFCAW applications the welding electrode is a metal electrode in the form of a consumable self-shielding welding electrode adapted to generate an arc-protecting gas curtain around the arc and the weld during use.

The shroud gas port is preferably adapted to direct the exiting shroud gas in a substantially radially outward direction, i.e. generally 90° to the axis of the torch body. However, it will be appreciated that the exiting shroud gas may be directed generally between about 30° to about 90° with respect to the axis of the torch body. The torch preferably includes an inner sleeve and an outer sleeve for defining therebetween a passage for the shroud gas, the shroud gas port being positioned at or near the distal end of the passage. Preferably both the inner sleeve and the outer sleeve circumscribe the torch.

The torch typically includes a fume gas extraction port adapted to receive fume gas from an area surrounding the welding site. The fume gas extraction port is ideally positioned radially intermediate (a) the shield gas port (if present) or the welding electrode and (b) the shroud gas port. The inner sleeve and the body or barrel of the torch define therebetween an extraction passage for fume gas extraction. Preferably the fume gas extraction port is disposed at the distal end of the extraction passage. In one embodiment the shroud gas port and the shield gas port are concentrically coaxially located at spaced relationship about the welding electrode.

The shroud gas port and the shield gas port are both preferably circular or annular in transverse cross-section. However, a complete circle or annulus is not necessary and a series of discrete ports may, for example, be arranged in a circle.

Whereas, in the absence of the shroud gas port and the shrouding gas this flow (the ‘wall jet’) continues in a radially outward direction, surprisingly, the Applicants have found that by introducing a radially outward component of velocity to the shroud gas, when fume is extracted from the torch, the resulting wall jet flow is substantially contained and within the space around the weld pool shrouded by the shroud gas the direction of gas flow along the face of the work being welded is radially inwards. In other words, the shroud gas curtain tends to form an envelope around the welding site, thus isolating the fume generation region from the surroundings and allowing the fume gas to be extracted from within the envelope. The exiling shroud gas may be considered as a “radial gas jet” forming an “aerodynamic flange” about the welding torch and the welding site. As a consequence, improved fume extraction efficiency via the fume gas extraction port may be obtained. In preferred embodiments the shroud gas port is adapted such that the exiting shroud gas is produced as a relatively thin “curtain” radiating away from the torch. However, in alternative embodiments the shroud gas port is adapted such that the exiting shroud gas is produced as an expanding “wedge” of gas radiating from the torch.

In one embodiment, at least the shroud gas port is axially adjustable relative to the shield gas port for allowing the welding operator to fine-tune the fume extraction efficiency. The torch may also include control means to control the flow rates of the shield gas, the shroud gas and the rate of fume gas extraction.

For SSFCAW applications the self-shielding welding electrode is preferably a consumable flux-cored type electrode. In preferred embodiments the flux includes carbonates and the arc-protecting gas curtain includes CO₂. The carbonates may be chosen from the group consisting of CaCO₃, BaCO₃, MnCO₃, MgCO₃, SrCO₃ and mixtures thereof. The flux may also include at least one alkaline earth fluoride such as CaF. The flux may further include at least one of the following elements: aluminium, magnesium, titanium, zirconium, lithium and calcium.

According to a third aspect of the present invention there is provided a method for extracting fume from a welding site where an electric arc is delivered to said welding site from a welding electrode, said method comprising: producing a shield gas curtain around said welding electrode and said welding site, producing a shroud gas curtain spaced radially outward from said welding electrode; and extracting fume gas from a position radially inward of said shroud gas curtain, wherein said shroud gas curtain includes a radially outward component of velocity.

In one embodiment the fume gas is extracted from a position radially intermediate the shield gas curtain and the shroud gas curtain. However, in alternative embodiments, in particular for PAW applications, the fume gas is extracted from a position radially intermediate the shield gas curtain and the welding electrode.

As discussed above, for GMAW applications, the welding electrode is a metal electrode preferably in the form of a consumable welding electrode, and for GTAW and PAW applications the welding electrode is a metal electrode in the form of a (non-consumable) tungsten electrode. For SSFCAW applications the welding electrode in the form of a consumable self-shielding welding electrode adapted to generate an arc-protecting gas curtain around the arc and the weld during use. The shield gas and/or the shroud gas are preferably chosen from the group consisting of: nitrogen, helium, argon, carbon dioxide or mixtures thereof. Any commercially available shield gas may be used for either the shroud or shield gas provided it is suitable for the chosen welding process. Since the shield gas provides sufficient shielding of the weld pool from atmospheric contamination, compressed air may be used for the shroud gas in some circumstances.

The shield gas flow rate may be about 5 to 50 l/min and the shroud gas flow rate about 1 to 501/min. The fume is preferably extracted from a location intermediate the heat source or shield gas curtain (or the self-shielding welding electrode) and the shroud gas curtain at a flow rate of between about 5 to 501/min. Typically the fume gas extraction flow rate is similar to the shielding gas flow rate, which the Applicant has surprisingly found is an order of magnitude less than conventional fume extract systems to provide the same degree of fume extraction. Preferably the ratio of shroud gas flow rate:shield gas flow rate is chosen to be about 2:1 to about 3:1. Preferably the ratio of fume gas extraction rate:shield gas flow rate is about 1:1.

The shroud gas and shield gas are typically supplied at room temperature, although this temperature is not critical. However, in one embodiment the shroud gas and/or the shield gas are cooled sufficiently to promote fume gas condensation. Cooling may be achieved by refrigeration of the shroud/shield gas or adiabatic expansion of the shroud/shield gas exiting the shroud/shield gas port. However, as will be appreciated any method of gas cooling would be suitable. It will be appreciated that cooling assists condensation of the metal vapour to a fine particulate material thereby allowing improved extraction efficiency. Furthermore, cooling the shroud/shield gas(s) advantageously reduces the temperature of the exhausted gas. In other embodiments at least a portion of the shroud gas and/or the shield gas includes a component reactive with a welding fume gas and/or a UV light-absorbing component.

The present invention provides an improvement to an arc welding torch having a welding electrode and at least one shield gas port adapted to direct a shield gas curtain around said welding electrode and a welding site, comprising: providing at least one shroud gas port spaced radially outward from the shield gas port and adapted to impart to an exiting shroud gas a radially outward component of velocity.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

Other than in the operating examples, or where otherwise indicated, all numbers expressing quantities of ingredients or reaction conditions used herein are to be understood as modified in all instances by the term “about”. Any examples are not intended to limit the scope of the invention. In what follows, or where otherwise indicated, “%” will mean “weight %”, “ratio” will mean “weight ratio” and “parts” will mean “weight parts”.

### BRIEF DESCRIPTION OF THE DRAWINGS

Preferred embodiments of the invention will now be described, by way of example only, with reference to the accompanying drawings in which:

FIG. 1 is a partly cut-away side view of prior art welding apparatus;

FIG. 2 is a sectional side view of apparatus according to the invention adapted for GMAW;

FIG. 3 is a sectional side view of apparatus according to the invention adapted for SSFCAW;

FIG. 4 is a sectional side view of apparatus according to the invention adapted for GTAW;

FIG. 5 is a sectional side view of apparatus according to the invention adapted for PAW; and

FIG. 6 is a graph of extraction efficiency versus the ratio of shroud gas flow rate and extraction flow rate for a GMAW application.

### DEFINITIONS

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

The terms “welding site” and “welding zone” may be used interchangeably herein, and the terms “fume” and “fume gas” are also used interchangeably herein. Fume gas is intended to not only refer to the gaseous products emanating from the welding process but also the fine particular matter which is also produced, such as metal dust. The term “welding” as discussed herein also includes “hard surfacing”, which is a process in which weld metal is deposited to repair a surface defect rather than to join two pieces of metal together.

### Preferred Embodiment of the Invention

Throughout the figures presented herein like features have been given like reference numerals. Further, as will be appreciated the arrows in the Figures that represent gas flows present simplified versions of the gas flow regimes.

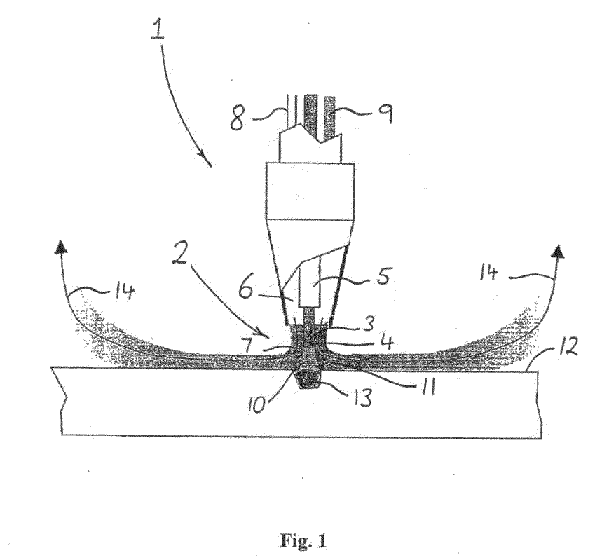

Referring initially to FIG. 1, a conventional GMAW torch 1 is shown comprising a heat source adapted to provide heat to welding site 2 from a consumable welding electrode 3. In the GMAW process the welding electrode 3 is a continuous welding wire 4 which is generally guided by a contact tube 5. A shield gas port 6 is also provided for passage of shield gas. The shield gas port 6 is adapted to direct a shield gas curtain 7 around the electrode 3 and the welding site 2 such that the shield gas curtain 7 closely surrounds the electrode 3. The welding wire 4 may include a fluxed core (not shown) and can be used with or without the shield gas curtain 7. The shield gas port 6 includes an upstream shield gas inlet 8, which is adapted for attachment to a suitable source of shield gas. The GMAW torch 1 also includes an electrical current conductor 9.

In use, a welding arc 10 is struck between the tip 11 of the welding electrode 3 and the work being welded 12. As a result, molten weld metal is transferred from the welding electrode 3 to a weld pool 13 that forms on the work being welded 12. Because of the high temperature environment, convection currents are created. In a conventional gas-shielded welding process, as best shown in FIG. 1, the Applicants have discovered that forced convection generates a buoyant “wall jet” along the horizontal surface of the work being welded 12, which jet radiates outwards from the welding torch 1 and that buoyancy-driven, i.e. natural, convection causes a fume-laden thermal plume 14 to be formed.

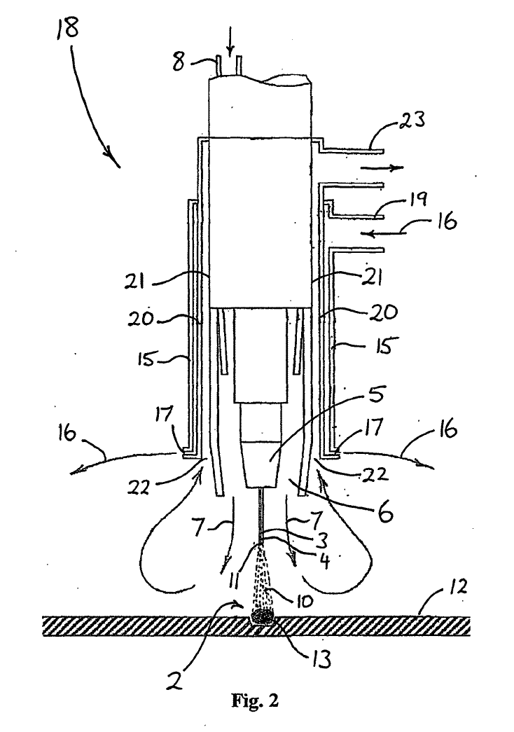

The conventional GMAW torch shown in FIG. 1 has been adapted according to the present invention, as shown in FIG. 2. To explain, an outer sleeve 15 is spaced radially outward from the welding electrode 3 and is provided for passage of a shroud gas 16. The outer sleeve 15 terminates in a shroud gas port 17 (typically circular in shape) which is adapted to impart to an exiting shroud gas 16 a radially outward component of velocity. Preferably the shroud gas port 17 faces radially outward to the longitudinal axis of the torch 18 to direct the exiting shroud gas curtain 16 in a substantially radially outward direction, thereby forming an “aerodynamic flange” about the welding site 2. However in other embodiments the shroud gas port 17 faces between about 45 and 90° to the longitudinal axis of the torch 18. The outer sleeve 15 preferably circumscribes the torch 18. An upstream shroud gas inlet 19 is provided which is adapted for attachment to a suitable source of shroud gas for supplying the shroud gas port 17. The shroud gas port 17 is axially positioned above the distal end of the contact tube 5 by a distance in the order of about 1 cm to allow “line of sight” for the welding operator.

An inner sleeve 20 may also be provided to define a fume gas extraction passage between the inner sleeve 20 and the body or the barrel 21 of the torch 18. The extraction passage terminates at its distal end at a fume gas extraction port 22 adapted to receive fume gas from the area surrounding the welding site 2. The extraction port 22 is positioned radially intermediate the shield gas port 6 and shroud gas port 17. The fume gas may be extracted through the fume extraction port 22 by connecting the port to any suitable source of extraction (typically a source of suction, e.g. a pump) via the downstream fume gas extraction outlet 23.

The method of extracting fume from a welding site 2 includes the steps of firstly producing a shield gas curtain 7 around the electrode 3 and the welding site 2. A shroud gas curtain 16 is then produced at a position radially outward from the shield gas curtain 7 and directed in a substantially radially outward direction. Fume gas is then extracted from a position radially intermediate the shield and shroud gas curtains 7 and 16 respectively. Control means (not shown) typically in the form of flow control values are then used to control the flow rates of one or both of the shroud gas port and shield gas port, and to control the extraction rate of the fume gas extraction port. The rate of fume gas extraction can readily be selected such that there is minimal disruption to the welding arc and excessive quantities of ambient air are not drawn into the welding arc 10 at the vicinity of the weld. Also, the precise axial distance between the arc welding torch 18 and the work being welded 12 may be adjusted so as to optimise fume extraction. The arc welding torch 18 is then useable for welding operations.

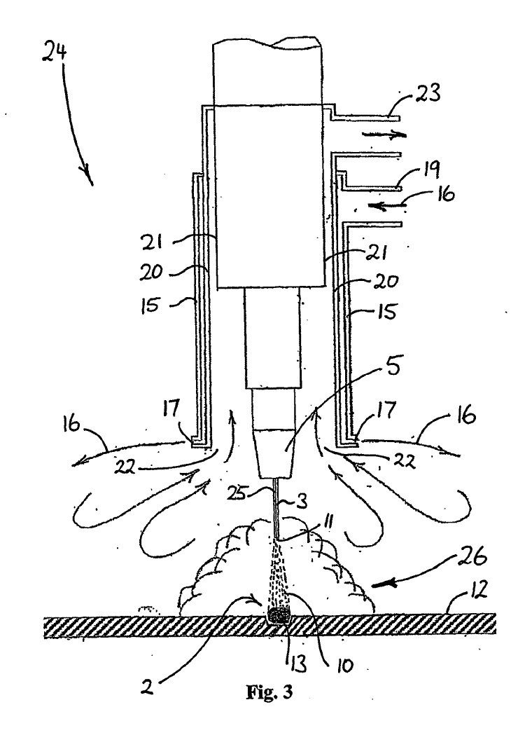

Referring now to FIG. 3, a torch 24 using a continuous, consumable, self-shielding flux-cored type welding electrode 25 is shown which is adapted according to the present invention. In operation, the flux core at the tip 11 of the welding electrode 3 generates a gas which forms an arc-protecting gas curtain 26 around the welding electrode 3 and the weld zone 2. The welding electrode flux includes metal carbonates thereby providing CO₂ in the arc-protecting gas curtain 26. The carbonates may be chosen from the group consisting of CaCO₃, BaCO₃, MnCO₃, MgCO₃, SrCO₃ and mixtures thereof. The flux also includes at least one alkaline earth fluoride, which may be CaF (fluorspar), and may also include at least one of the following elements: aluminum, magnesium, titanium, zirconium; lithium and calcium for deoxidation and/or denitrification of the weld. In this Figure, the shield gas port of the previous Figures has been “removed” since the welding electrode 3 provides the arc-protecting gas curtain 26. However, it will be appreciated that a shield gas port could also be employed to provide additional shielding of the welding site 2. The torch 24 also has a fume gas extraction port 22 at its distal end and a fume gas outlet 23. Similarly to the torch shown in FIG. 2, a flow of shroud gas is supplied to an inlet 19 and issues from a shroud gas port 17 at the distal end of the torch 24. The configuration of the gas port 17 and its operation to provide a flow of shroud gas with a radially outward component of velocity is essentially the same as for the torch 18 shown in FIG. 2.

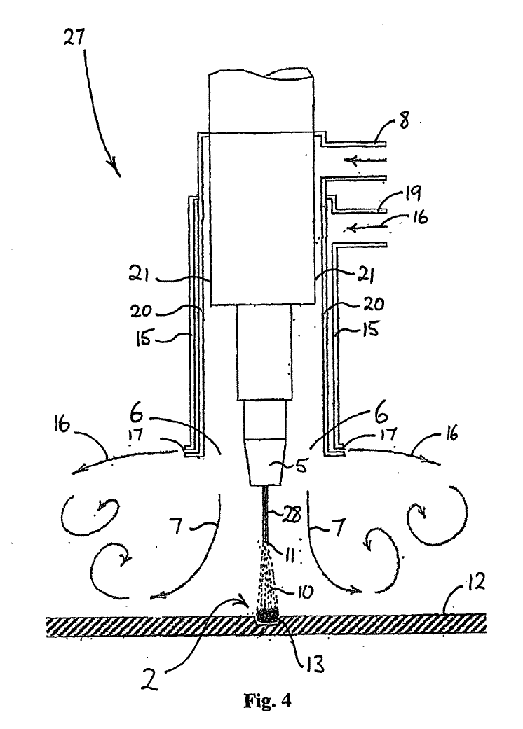

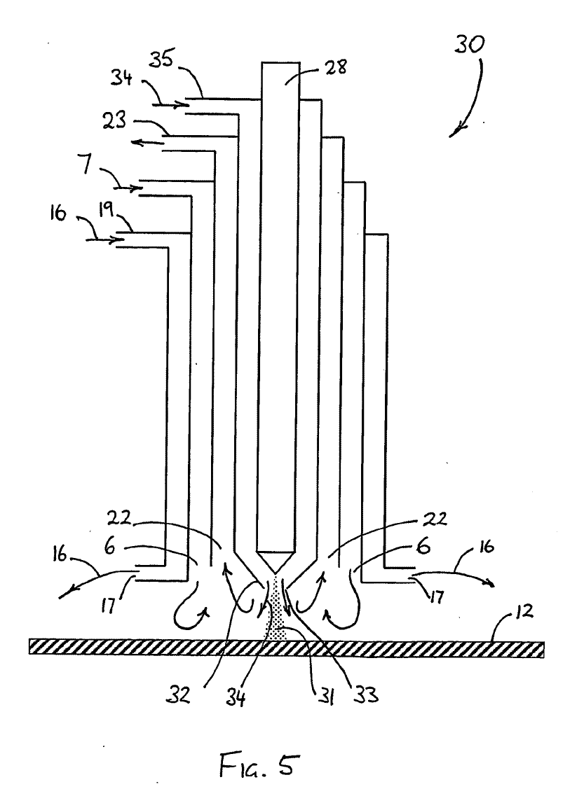

A welding torch 27 for use in GTAW is shown in FIG. 4 comprising a non-consumable tungsten welding electrode 28, and PAW torch 30 are shown in FIG. 5. In operation, welding torch 27 delivers an electric arc 10 between the tip 11 of the tungsten electrode 28 and the work 12 to be welded to heat the weld 13. However, welding torch 30 delivers a plasma 31 to the work 12 to be welded to heat the weld 13. The torch 30 as shown in FIG. 5 includes a gas nozzle 32 defining orifice 33 for the supply of a shaping or orifice gas 34 which is adapted to constrict the plasma 31 to a fine jet. The gas nozzle 32 includes an upstream gas inlet 35, which is adapted for attachment to a suitable source of shaping or orifice gas (also referred to herein as a shield gas). The torch 27 shown in FIG. 4 includes a shield gas port 6 for passage of a shield gas 7. Welding torch 30 includes a fume gas extraction port 22 and a fume gas outlet 23 similar to the corresponding port and outlet of the torch shown in FIG. 2. In general, the operation of the fume extraction and the gas flow regime recited by use of the shroud gas port 17 are analogous to the corresponding operations and gas flow regime of the torch shown in FIG. 2.

With reference again to FIG. 2 of the drawings, during a gas metal arc welding process, the tip 11 of the electrode 4 is typically held an appreciable distance above the surface of the work being welded 12. Accordingly, there is an appreciable separation between the shroud gas curtain 16 and the “wall jet” that travels along the surface of the work being welded 12. The shroud gas curtain 16 itself is not a source of welding plume, rather, the applicants have found that it reduces the tendency of the welding operation to eject plume into regions of the surrounding environment remote from the welding arc 10. Without wishing to be bound by theory, the Applicants suspect that the shroud gas curtain 16 substantially alters the structure of the flow in the “wall jet”, wherein the wall jet flow direction is now reversed in comparison to prior art devices and is directed radially inwards towards the torch axis. Therefore, the illustrated arc welding torches succeed in confining the fume gas in a relatively small region in the immediate vicinity of the welding site 2, from where it may be efficiently extracted by the fume gas extraction port 22. In addition, it will be appreciated that due to the reverse in the flow in the “wall jet”, the shielding efficiency of the shielding gas 7 may be is improved.

The shroud gas 16 and/or shield gas 7 are preferably chosen from the group consisting of: nitrogen, helium, argon, carbon dioxide and mixtures thereof (which mixtures may also include, for example, small proportions of oxygen). However, the shroud gas 16 may be compressed air since it does not enter the immediate vicinity of the weld. The flow rates of shroud gas 16 and shield gas 7 are typically between about 1 to 50 l/min, and the fume gas is typically extracted at a flow rate of between about 5 to 50 l/min.

Ideally, the illustrated welding torches are used in welding operations where the torch is vertical and the work piece horizontal, i.e. where the torch is normal to the work piece. However, it will be appreciated that the illustrated welding torches will substantially extract fume when held at angles other than normal to the work piece.

The shroud gas port 17 may be axially adjustable in order for the welding operator to fine tune the torch to maximise fume extraction. In other embodiments, one or more of the shield gas port 6, shroud gas port 17 and fume gas extraction ports 22 may include a plurality of sub-ports (not shown).

It will be appreciated that the illustrated apparatus provides relatively improved fume extraction efficiency.

### EXAMPLES

In one example, a commercial GMAW torch adapted according to the present invention was configured with a 1.2 mm Autocraft LW1 welding wire/electrode and Argoshield® Universal gas. Test conditions were chosen to provide “high fume”, i.e. 250 Amps at 32 Volts. The welding torch was configured to provide “stand oft” distances of: workpiece to torch nozzle=22 mm; workpiece to shroud gas curtain (radial jet)=22 mm and 32 mm (22 mm maximum efficiency and 32 mm maximum weld pool visibility); and radial distance welding wire/electrode to shroud gas curtain (radial jet) outlet=40 mm. Better than 85% fume removal was achieved with 22 mm radial jet stand off.

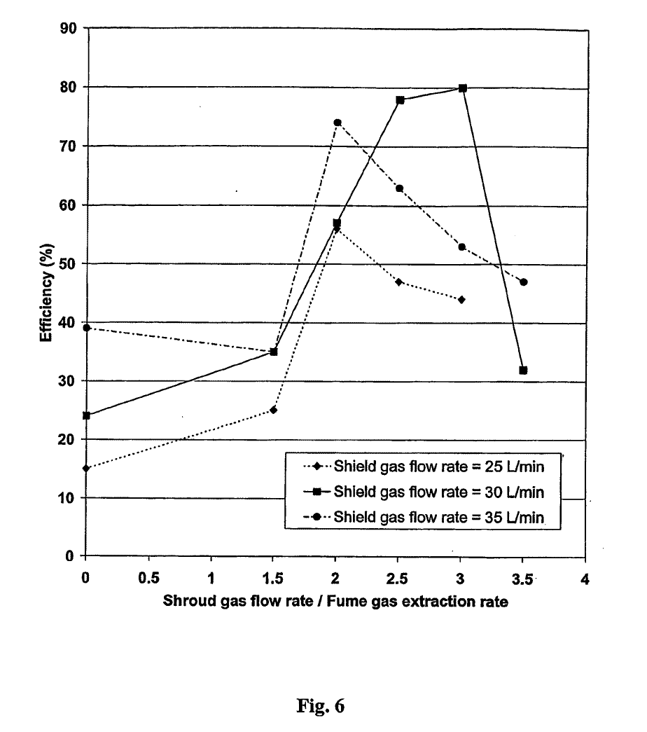

In other examples, welding tests were conducted wherein the extraction flow rate was held constant at 101/min and the shroud gas flow rate was varied for 3 different shielding gas flow rates, viz 25, 30 and 35 l/min. As can be seen in FIG. 6, the extraction efficiency was plotted as a function of the ratio of shroud gas flow rate and extraction flow rate. The extraction efficiency was measured by welding with and without the apparatus of the invention in a standard fume box. The weight of fume collected on the filter was compared and the efficiency is expressed as the following ratio: (total weight of fume without the apparatus of the invention−total weight of fume with the apparatus of the invention)/(total weight of fume without the apparatus of the invention). Whilst it is possible to extract a portion of the fume with no shroud gas flow, it is clearly possible to significantly improve the extraction efficiency by incorporating the shroud gas.

From this experimental data, simulations of the welding process and observations, the optimum shroud gas flow rate appears to be a function of the shield gas flow rate, which is preferably about 2:1 to about 3:1. Further, the fume gas is preferably extracted at a rate equivalent to the rate of addition of shield gas. In other words, a significant portion of the shield gas (bearing the fume gas) is extracted by fume gas extraction port, and the shroud gas is mostly lost to atmosphere. For example, one typical set-up of the apparatus of the invention comprises a shroud gas flow rate of 30 l/min, a shield gas flow rate of 15 l/min and a fume gas extraction rate of 15 l/min. However, it will be appreciated that other flow/extraction rate configurations will also be suitable.

Although the invention has been described with reference to specific examples, it will be appreciated by those skilled in the art that the invention may be embodied in many other forms.

1. An arc welding torch having a welding electrode and at least one shield gas port adapted to direct a shield gas curtain around said welding electrode and a welding site, and at least one shroud gas port spaced radially outward from the shield gas port and adapted to impart to an exiting shroud gas a radially outward component of velocity.

2. An arc welding torch for use in a self-shielded arc welding process having a self-shielding welding electrode adapted to generate in use an arc-protecting gas curtain around the arc and the weld, and at least one shroud gas port spaced radially outward from said welding electrode and adapted to impart to an existing shroud gas a radially outward component of velocity.

3. An arc-welding torch according to claim 1 wherein said welding electrode is a consumable welding electrode for GMAW applications.

4. A torch according to claim 1 wherein said welding electrode is a tungsten electrode for GTAW or PAW applications.

5. An arc welding torch according to claim 2 wherein said self-shielding welding electrode is a consumable flux-cored electrode.

6. An arc welding torch according to claim 5 wherein said flux includes carbonates and said arc-protecting gas curtain includes CO₂.

7. An arc welding torch according to claim 6 wherein said carbonates are chosen from the group consisting of CaCO₃, BaCO₃, MnCO₃, MgCO₃, SrCO₃ and mixtures thereof.

8. An arc welding torch according to claim 6 or claim 7 wherein said flux includes at least one alkaline earth fluoride.

9. An arc welding torch according to claim 8 wherein said alkaline earth fluoride is CaF.

10. An arc welding torch according to any one of claims 6 to 9 wherein said flux includes at least one of the following elements: aluminium, magnesium, titanium, zirconium, lithium and calcium.

11. An arc welding torch according to any one of the preceding claims wherein said shroud gas port is adapted to direct said exiting shroud gas in a substantially radially outward direction.

12. An arc welding torch according to any one of the preceding claims wherein said torch includes an outer sleeve circumscribing said torch for defining a shroud gas passage, said shroud gas port being positioned at or near a free end of said outer sleeve.

13. An arc welding torch according to any one of the preceding claims wherein said torch includes a fume gas extraction port adapted to receive a fume gas from an area surrounding said welding site.

14. An arc welding torch according to claim 13 wherein said fume gas extraction port is positioned radially inward of said shroud gas port.

15. An arc welding torch according to claim 13 or claim 14 wherein said fume gas extraction port is positioned radially intermediate said shield gas port and said shroud gas port.

16. An arc welding torch according to claim 13 or claim 14 wherein said fume gas extraction port is positioned radially intermediate said shield gas port and said welding electrode.

17. An arc welding torch according to any one of claims 13 to 16 wherein said torch includes an inner sleeve circumscribing said torch for defining a fume gas extraction passage, said fume gas extraction port being positioned at or near a free end of said inner sleeve.

18. A method for extracting fume from a welding site where an electric arc is delivered to said welding site from a welding electrode, said method comprising: producing a shield gas curtain around said welding electrode and said welding site, producing a shroud gas curtain spaced radially outward from said welding electrode; and extracting fume gas from a position radially inward of said shroud gas curtain, wherein said shroud gas curtain includes a radially outward component of velocity.

19. A method according to claim 18, wherein said fume gas is extracted from a position radially intermediate said shield gas curtain and said shroud gas curtain.

20. A method according to claim 18, wherein said fume gas is extracted from a position radially intermediate said shield gas curtain and said welding electrode.

21. A method according to any one of claims 18 to 20, wherein said welding electrode is a consumable metal welding electrode for GMAW applications.

22. A method according to any one of claims 18 to 20, wherein said welding electrode is a tungsten electrode for GTAW or PAW applications.

23. A method according to any one of claims 18 to 20, wherein said welding electrode is in the form of a consumable self-shielding welding electrode adapted to generate an arc-protecting gas curtain around the arc and the welding site during use in SSFCAW applications.

24. A method according to claim 23, wherein said self-shielding welding electrode is a consumable flux-cored electrode.

25. A method according to any one of claims 18 to 24, wherein said shroud gas is directed in a substantially radially outward direction.

26. A method according to any one of claims 18 to 25 wherein said fume gas is extracted through a fume gas extraction port adapted to receive said fume gas from an area surrounding said welding site.

27. A method according to any one of claims 18 to 26 wherein the ratio of shroud gas flow rate:shield gas flow rate is chosen to be about 2:1 to about 3:1.

28. A method according to any one of claims 18 to 27 wherein the ratio of fume gas extraction rate:shield gas flow rate is about 1:1.
